(19) United States
(12) Patent Application Publication
(10) Pub. No.: US 2017/0076176 A1
(43) Pub. Date: Mar. 16, 2017

(54) METHOD AND SYSTEM FOR DISPLAYING ITEM RELATED INFORMATION IN VIDEO STREAMING

(71) Applicants: LE HOLDINGS (BEIJING) CO., LTD., Beijing (CN); LE SHI ZHI XIN ELECTRONIC TECHNOLOGY (TIANJIN) LIMITED, Tianjin (CN)

(72) Inventors: Lei Yan, Tianjin (CN); Haibo TANG, Tianjin (CN)

(21) Appl. No.: 15/245,110

(22) Filed: Aug. 23, 2016

Related U.S. Application Data
(63) Continuation of application No. PCT/CN2016/089116, filed on Jul. 7, 2016.

(30) Foreign Application Priority Data
Sep. 16, 2015 (CN) 201510591642.8

(51) Int. Cl. G06K 9/62; G06F 3/0481; G06K 9/00

(52) U.S. Cl. CPC G06K 9/6201; G06K 9/00744; G06K 9/00671; G06F 3/0481; G06K 2009/6213; G06F 3/04842

(57) ABSTRACT

The embodiment of the present disclosure discloses a method and a system for displaying item related information in video streaming. The method comprises: recognizing and analyzing frame images in played video streaming by a client, and transmitting regional images according with item characteristics to a server; adding a focus frame on the regional image by the client when the regional images and pre-stored item sample pictures are matched by the server and the match is successful; and displaying a floating layer window after the client receives a click operation of the focus frame, and displaying related information of the matched items acquired from the server in the floating layer window. According to the embodiment of the present disclosure, the related information of the items may be acquired without searching the items through an internet and the like, and items in the video streaming are conveniently known.

### CROSS-REFERENCE TO RELATED APPLICATIONS

The present disclosure is a continuation of International Application No. PCT/CN2016/089116 filed on Jul. 7, 2016, which is based upon and claims priority to Chinese Patent Application No. 201510591642.8, entitled “METHOD AND SYSTEM FOR DISPLAYING ITEM RELATED INFORMATION IN VIDEO STREAMING”, filed on Sep. 16, 2015, the entire contents of all of which are incorporated herein by reference.

### TECHNICAL FIELD

The disclosure generally relates to the technical field of video processing and in particular relates to a method and a system for displaying item related information in video streaming.

### BACKGROUND

With rapid growth of social economy, the traditional shopping online has developed rapidly. However, the shopping online only may know the needed commodities by description, pictures and the like. On one hand, characteristics of the commodities cannot be well shown to users; on the other hand, users possibly buy non-ideal commodities. Occurrence of “TV shopping” and “video shopping” is facilitated on the basis.

So a few years ago, the “TV shopping” became one of the most important ways of daily shopping. The “TV shopping” is one of goods selling modes and specifically refers to allowing users to watch TV at home to acquire the commodity information and ordering the commodities. The ordering form may be telephone ordering or network ordering, and finally the commodities are distributed to users' homes. Payment methods may include pay on delivery, mail remittance, credit card payment and the like. The “TV shopping” mode almost occurs in local stations of broadcasting and TV in various regions.

The “video shopping” mainly promotes the commodities to users based on video streaming display. The commodities are displayed in a video streaming manner and may be vividly and really displayed all around. The video shopping form brings particular user experience to the users. However, the disadvantages are that the users need to watch many videos while purchasing the commodities and the operation is not rapid enough. The “video shopping” has been adopted by various known shopping websites at present, such as Taobao, Suning E-commerce and the like.

The “TV shopping” and “video shopping” belong to advertising display performed aiming at specific commodities. However, some defects exist in the followings: if a user likes a coat worn by a star, or a pair of glasses, a mobile phone and the like in a hit TV show; however, if the user wants to know correlation effect or purchase information and the like of the item, the information only may be searched on an internet or other places, and due to the absence of keywords needed by search or inaccuracy of the keywords, accurate information cannot be searched often.

### SUMMARY

The embodiment of the present disclosure discloses a method and a system for displaying item related information in video streaming, and aims to solve the problem in the prior art that the users cannot accurately acquire the item related information in the video streaming.

According to one aspect of the present disclosure, the embodiment of the present disclosure provides a method for displaying item related information in video streaming, including:

recognizing and analyzing frame images in played video streaming by a client, and transmitting regional images according with item characteristics to a server;

adding a focus frame on the regional images by the client when the regional images and pre-stored item sample pictures are matched by the server and the match is successful;

and displaying a floating layer window after the client receives a click operation of the focus frame, and displaying related information of the matched items acquired from the server in the floating layer window.

The embodiment of the present disclosure also provides a method for displaying item related information in video streaming, including:

receiving regional images according with item characteristics acquired by recognizing and analyzing frame images in the played video streaming through the client by the server;

matching the regional images and the pre-stored item sample pictures by the server;

and transmitting the related information of the matched items to the client by the server if the match is successful so as to allow the client to add a focus frame on the regional images, displaying a floating layer window after the client receives the click operation of the focus frame, and displaying the related information of the matched items in the floating layer window.

According to another aspect of the present disclosure, the embodiment of the present disclosure provides an electronic device for displaying item related information in video streaming, including: at least one processor; and a memory communicably connected with the at least one processor for storing instructions executable by the at least one processor, wherein execution of the instructions by the at least one processor causes the at least one processor to:

recognize and analyze the frame images in the played video streaming, and transmit the regional images according with item characteristics to a server;

add a focus frame on the regional images when the regional images and pre-stored item sample pictures are matched by the server and the match is successful;

display a floating layer window after a click operation of the focus frame is received, and display related information of the matched items acquired from the server in the floating layer window.

The embodiment of the present disclosure also provides an electronic device for displaying item related information in video streaming, including: at least one processor; and a memory communicably connected with the at least one processor for storing instructions executable by the at least one processor, wherein execution of the instructions by the at least one processor causes the at least one processor to:

receive regional images according with item characteristics acquired by recognizing and analyzing frame images in the played video streaming by the client;

match the regional images and pre-stored item sample pictures in the item information base, and transmit the related information of the matched items to the client if the match is successful.

According to another aspect of the present disclosure, the present disclosure provides a computer program, including computer readable codes, wherein the method for displaying item related information in video streaming is executed by computing device when the computer readable codes are operated on the computing device.

According to another aspect of the present disclosure, the present disclosure provides a computer readable medium, wherein the computer program is stored.

The present disclosure has the beneficial effects that:

according to the method and the system for displaying item related information in video streaming provided by the embodiment of the present disclosure, the client recognizes and analyzes frame images in played video streaming, and transmits regional images according with item characteristics to a server; the server matches the regional images and the pre-stored item sample pictures; if the match is successful, the server transmits the related information of the matched items to the client; the client adds a focus frame on the regional images; and the client displays a floating layer window after receiving a click operation of the focus frame, and displays the related information of the matched items acquired from the server in the floating layer window. According to the related information of the pre-stored items at the server, the related information of the items is displayed in the played video streaming at the client, the related information of the items may be acquired without searching the items through the internet and the like, and the items in the video streaming are conveniently known.

Moreover, the floating layer window is displayed at the client, and normal play of the video streaming is not influenced.

The joint degree of the related information of the items and the video streaming is greatly improved, and users may well know related information of interested items in the video streaming watching process.

The description above is only the summary of the technical scheme of the present disclosure, in order to clearly know the technical means of the present disclosure and implement the means according to the contents of the specification, and in order to enable the previous and other aims, characteristics and advantages of the present disclosure to be obvious and easy to understand, the specific embodiments of the present disclosure are particularly listed in the followings.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 shows the flow chart of steps of the method for displaying item related information in video streaming in the embodiment I of the present disclosure.

FIG. 2 shows the flow chart of steps of the method for displaying item related information in video streaming in the embodiment II of the present disclosure.

FIG. 3 shows the structure diagram of the system for displaying item related information in video streaming in the embodiment III of the present disclosure.

FIG. 4 shows the structure diagram of the system for displaying item related information in video streaming in the embodiment IV of the present disclosure.

FIG. 5 schematically shows the block diagram of an electronic device for executing the method according to the present disclosure.

FIG. 6 schematically shows a storage unit for keeping or carrying the program codes for realizing the method according to the present disclosure.

### DETAILED DESCRIPTION

In order to enable the aims, technical schemes and advantages of the embodiments of the present disclosure to be clear, the technical schemes in the embodiments of the present disclosure are clearly and completely described by combining the following drawings in the embodiments of the present disclosure, obviously, the described embodiments are not total embodiments, but one part of the embodiments of the present disclosure. Based on the embodiments in the present disclosure, all other embodiments obtained by the ordinary technical personnel in the field under the condition that creative labor is not contributed belong to the protection scope of the present disclosure.

### Embodiment I

The method for displaying item related information in video streaming provided by the embodiment I of the present disclosure is introduced in details.

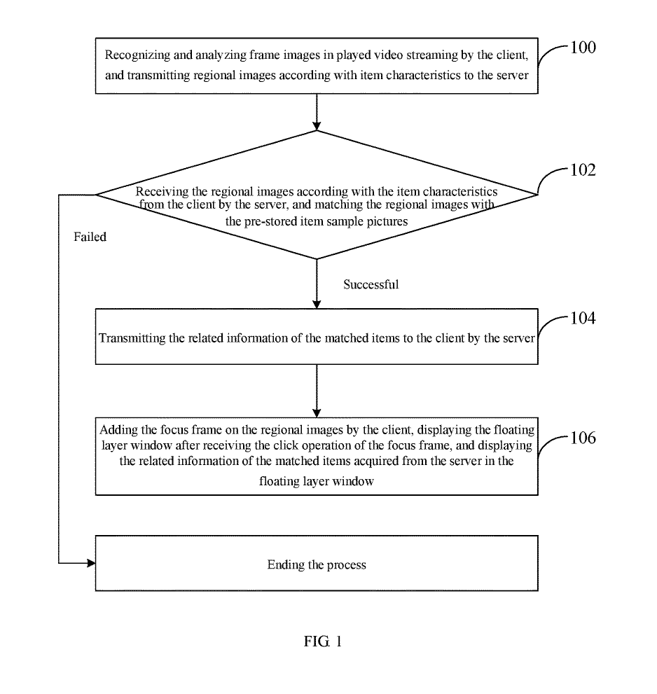

The FIG. 1 shows the flow chart of the steps of the method for displaying item related information in video streaming in the embodiment I of the present disclosure.

Step 100, recognizing and analyzing frame images in the played video streaming by the client, and transmitting regional images according with item characteristics to the server.

The client may be a web player. The client recognizes and analyzes the frame images in the played video streaming, acquires frame images of items appearing in the video streaming through recognition and analysis, namely acquires the regional images according with item characteristics.

Step 102, receiving the regional images according with item characteristics from the client by the server, matching the regional images and the pre-stored item sample pictures, executing a step 104 if the match is successful, otherwise, ending the process.

The pre-stored item sample pictures may be pre-stored in a database of the server, and other related information associated with items, such as item numbers, item types, brands, color and appearance characteristics, purchase channels and the like, may be pre-stored in the database of the server, wherein the item numbers have uniqueness and are used for distinguishing different items. The item sample pictures and the item numbers have corresponding relations, and unique item numbers may be determined by virtue of the item sample pictures, namely unique items are obtained.

Step 104, transmitting the related information of the matched items to the client by the server.

The matched items refer to items which correspond to the pre-stored item sample pictures in the database of the server after the regional images and the pre-stored item sample pictures are successfully matched.

The related information of the matched items may include information related to the items pre-stored in the database.

Step 106, adding the focus frame on the regional images by the client, displaying the floating layer window after receiving the click operation of the focus frame, and displaying the related information of the matched items acquired from the server in the floating layer window.

The client may add the focus frame on the whole regional images, also may add the focus frame at specific positions of items displayed in the regional images and may perform the click operation and the like on the focus frame. When a user clicks on the focus frame, the floating layer window is displayed on the client, and the related information of the matched items is displayed in the floating layer window. The displayed floating layer window may be optionally dragged or zoomed in and out on a playing interface of the video streaming, and meanwhile, the displayed floating layer window may be closed or subjected to other operations.

Normal play of the video streaming is not influenced by the operations of adding the focus frame on the regional images, receiving the click operation of the focus frame, displaying the floating layer window and displaying the related information of the matched items in the floating layer window.

In conclusion, according to the method for displaying item related information in video streaming provided by the embodiment of the present disclosure, the related information of the items is pre-stored at the server and displayed in the played video streaming of the client, the related information of the items may be acquired without searching the items through the internet and the like, and items in the video streaming are conveniently known.

Moreover, the floating layer window is displayed at the client, and normal play of the video streaming is not influenced.

The joint degree of the related information of the items and the video streaming is greatly improved, and the users may well know the related information of interested items in the video streaming watching process.

### Embodiment II

The method for displaying item related information in video streaming provided by the embodiment II of the present disclosure is introduced in details.

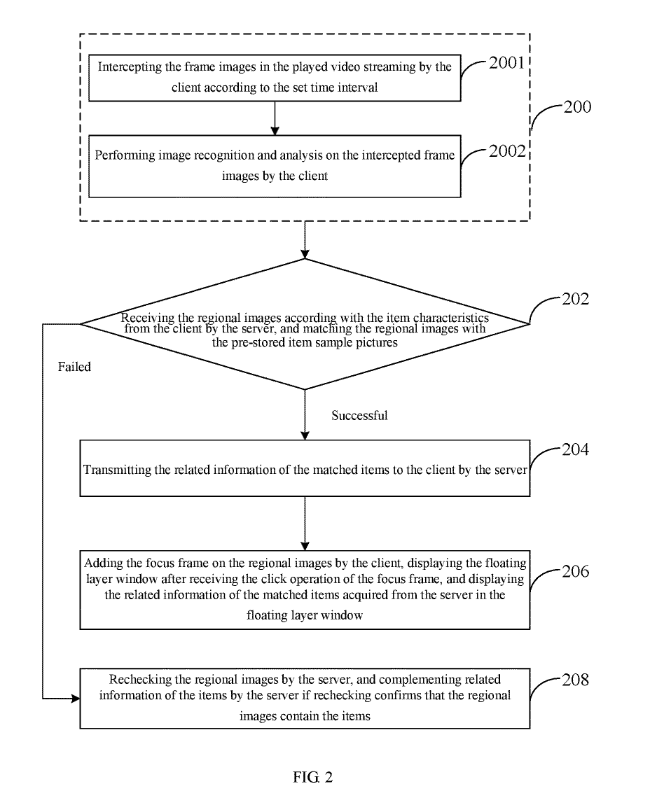

The FIG. 2 shows the flow chart of the steps of the method for displaying item related information in video streaming in the embodiment II of the present disclosure.

Step 200, recognizing and analyzing frame images in the played video streaming by the client, and transmitting regional images according with item characteristics to the server.

The client may be a web player. The client recognizes and analyzes the frame images in the played video streaming, acquires frame images of items appearing in the video streaming through recognition and analysis, namely acquires the regional images according with item characteristics.

Preferably, in the step 200, the step of recognizing and analyzing the frame images in the played video streaming by the client may include the following.

Step 2001, intercepting the frame images in the played video streaming by the client according to the set time interval.

The preset time interval may be 3 seconds or other time and also may be specifically set according to actual situation.

Step 2002, performing image recognition and analysis on the intercepted frame images by the client.

When the frame images are subjected to image recognition and analysis, preset item marked characteristics, such as item types, item forms, item colors, color distribution and the like may be compared with image characteristics of the frame images, and frame images of which the image characteristics accord with the item marked characteristics of a certain threshold rate are determined as the regional images according with item characteristics. The certain threshold rate may be 80% or may be set according to actual situation.

The image recognition and analysis of the frame images also may adopt any existing image recognition and analysis technology, and the image recognition and analysis is not specifically limited in the embodiment of the present disclosure.

Step 202, receiving the regional images according with the item characteristics from the client by the server, matching the regional images with the pre-stored item sample pictures, executing a step 204 if the match is successful; otherwise executing a step 208.

The pre-stored item sample pictures may be pre-stored in an item information base of the server, and other related information associated with items, such as item numbers, item types, brands, color and appearance characteristics, purchase channels and the like, may be pre-stored in the item information base of the server, wherein the item numbers have uniqueness and are used for distinguishing different items. The item sample pictures and the item numbers have corresponding relations, and unique item numbers may be determined by virtue of the item sample pictures, namely unique items are obtained. The item related information in the item information base may be manually and directly recorded, and the items in the video streaming may be automatically recognized by the client, reported to the server after recognition, checked by backstage staff and recorded.

Step 204, transmitting the related information of the matched items to the client by the server.

The matched items refer to items which correspond to the pre-stored item sample pictures in the item information base of the server after the regional images and the pre-stored item sample pictures are successfully matched.

The related information of the matched items may include information related to the items pre-stored in the item information base.

If the match is successful, the server also may record the time information of the matched items appearing in the current video to the item information base. Due to repeated successful matches, the total time information of the matched items appearing in the current video may be recorded in the item information base.

After the client receives the user instruction, the time information of the matched items appearing in other places of the current video is acquired from the server, and the client displays at least one other video frame of the matched items appearing in the current video.

The matched items may appear for several times in the current video, and the appearing time each time may be recorded in the item information base. After the matched items appears in the current video, video frames which correspond to other time points of the matched items appearing in the current video may be displayed in the client according to the item numbers and item appearing time information, and display effects of the matched items in different video frames of the current video are conveniently viewed.

After the client receives the user instruction, the time information of the matched items appearing in other videos is acquired from the server, and the client displays at least one video frame of the matched items appearing in the other videos.

The matched items may appear in the current video or other videos. The related information of videos in which the matched items appear also may be stored in the item information base of the server, and the related information of the videos may include video numbers, video names, video introductions, item numbers in the videos, time information of item appearing and the like, wherein the video numbers have the uniqueness.

When the matched items appear in the current video, other videos of the matched items may be displayed in the client through the item numbers of the matched items, the video numbers and the time information of item appearing, any one video is selected by the user, and at least one video frame of the matched items appearing in the selected video may be specifically displayed.

If the user knows the item number of a certain item, the item number may be searched at the client, and a video including an item which corresponds to the item number is obtained.

The user instruction may serve as an operating instruction of allowing the user to check the display effects of the matched items in the current video or other videos, and the generation and operation form of the user instruction and the like are not specifically limited in the embodiment of the present disclosure.

Step 206, adding the focus frame on the regional images by the client, displaying the floating layer window after receiving the click operation of the focus frame, and displaying the related information of the matched items acquired from the server in the floating layer window.

The client may add the focus frame on the whole regional image or at a specific position in which the items are displayed in the regional image, and also may perform operations such as click on the focus frame. After the user clicks on the focus frame, the floating layer window is displayed at the client, the related information of the matched items is displayed in the floating layer window, the floating layer window may be optionally dragged or zoomed in and out on a playing interface of the video streaming, and meanwhile, the displayed floating layer window may be closed or subjected to other operations.

Normal play of the video streaming is not influenced by the operations of adding the focus frame on the regional images, receiving the click operation of the focus frame, displaying the floating layer window and displaying the related information of the matched items in the floating layer window.

Step 208, rechecking the regional images by the server, and complementing the related information of the items by the server if rechecking confirms that the regional images contain the items.

The server rechecks the regional images, a to-be-rechecked regional image may be uploaded to a to-be-recognized item background, whether the regional image contains items is manually checked, if so, the related information of the items may be complemented in the item information base of the server, and the complemented related information of the items may be utilized like related information of other items.

In conclusion, according to the method for displaying item related information in video streaming provided by the embodiment of the present disclosure, the related information of the items is pre-stored at the server and displayed in the played video streaming of the client, the related information of the items may be acquired without searching the items through the internet and the like, and items in the video streaming are conveniently known.

Moreover, the floating layer window is displayed at the client, and normal play of the video streaming is not influenced.

The joint degree of the related information of the items and the video streaming is greatly improved, and the users may well know the related information of interested items in the video streaming watching process.

### Embodiment III

The system for displaying item related information in video streaming provided by the embodiment III of the present disclosure is introduced in details.

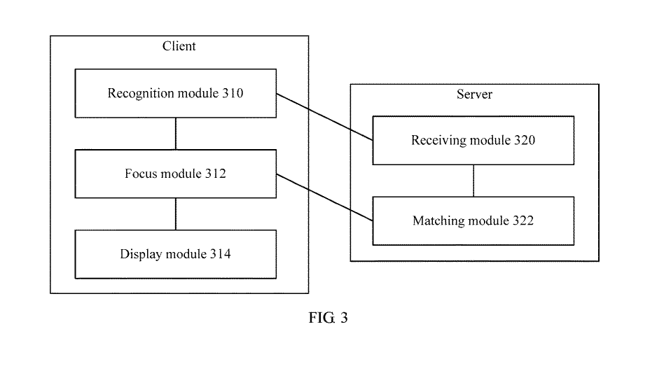

The FIG. 3 shows the structure diagram of the system for displaying item related information in video streaming in the embodiment III of the present disclosure.

The system may include: a client and a server, wherein, the client may include: a recognition module 310, a focus module 312 and a display module 314.

The server may include: a receiving module 320 and a matching module 322.

Functions of various modules and relations among the modules are respectively introduced in the following details.

The recognition module 310, used for recognizing and analyzing frame images in the played video streaming, and transmitting the regional images according with the item characteristics to the server.

The focus module 312, used for adding a focus frame on the regional image when the regional images and pre-stored item sample pictures are matched by the server and the match is successful.

The display module 314, used for displaying a floating layer window after receiving a click operation of the focus frame, and displaying related information of the matched items acquired from the server in the floating layer window.

The receiving module 320, used for receiving regional images according with item characteristics acquired by recognizing and analyzing frame images in the played video streaming by the client.

The matching module 322, used for matching the regional images with the item sample pictures pre-stored in the item information base, and transmitting the related information of the matched items to the client if the match is successful.

In conclusion, according to the system for displaying item related information in video streaming provided by the embodiment of the present disclosure, the related information of the items is pre-stored at the server and displayed in the played video streaming of the client, the related information of the items may be acquired without searching the items through the internet and the like, and items in the video streaming are conveniently known.

Moreover, the floating layer window is displayed at the client, and normal play of the video streaming is not influenced.

The joint degree of the related information of the items and the video streaming is greatly improved, and the users may well know the related information of interested items in the video streaming watching process.

### Embodiment IV

The system for displaying item related information in video streaming provided by the embodiment IV of the present disclosure is introduced in details.

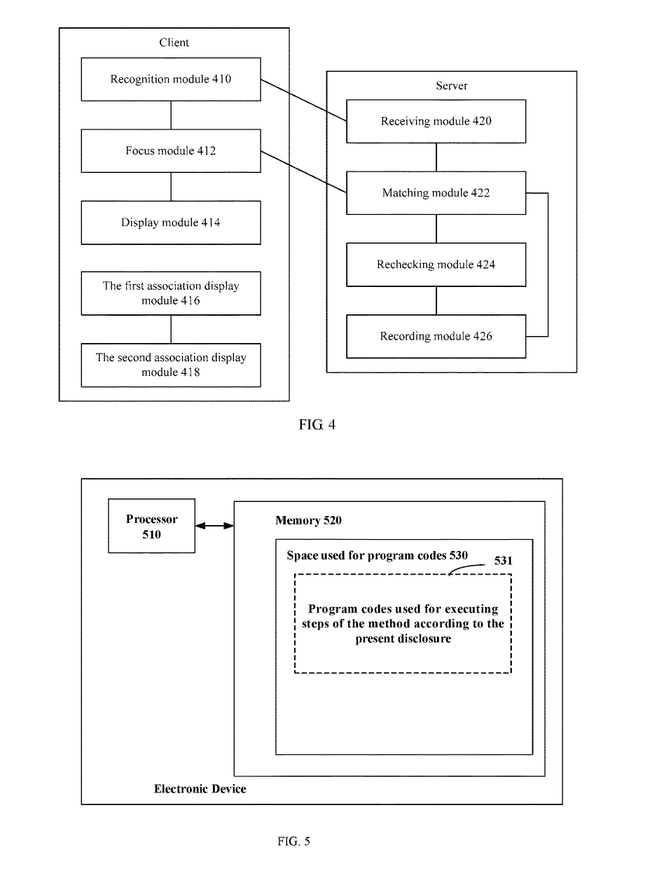

The FIG. 4 shows the structure diagram of the system for displaying item related information in video streaming in the embodiment IV of the present disclosure.

The system may include: a client and a server, wherein, the client may include: a recognition module 410, a focus module 412, a display module 414, a first association display module 416 and a second association display module 418.

The server may include: a receiving module 420, a matching module 422, a rechecking module 424, a recording module 426, a first time information transmitting module and a second time information transmitting module.

Functions of various modules and relations among the modules are respectively introduced in the following details.

The recognition module 410, used for recognizing and analyzing frame images in played video streaming, and transmitting regional images according with item characteristics to a server.

Preferably, the recognition module 410 is used for intercepting the frame images in the played video streaming according to the preset time interval, performing image recognition and analysis on the intercepted frame images, and transmitting the regional images according with item characteristics to the server.

The focus module 412, used for adding a focus frame on the regional image when the regional images and pre-stored item sample pictures are matched by the server and the match is successful.

The display module 414, used for displaying a floating layer window after receiving a click operation of the focus frame, and displaying related information of the matched items acquired from the server in the floating layer window.

The first association display module 416, used for acquiring time information of the matched items appearing in other places of the current video from the server after receiving a user instruction, and displaying at least one other video frame of the matched items appearing in the current video.

The second association display module 418, used for acquiring time information of the matched items appearing in the other videos from the server after receiving a user instruction, and displaying at least one other video frame of the matched items appearing in the other videos.

The receiving module 420, used for receiving regional images according with item characteristics acquired by recognizing and analyzing frame images in the played video streaming by the client.

The matching module 422, used for matching the regional images with the item sample pictures pre-stored in the item information base, and transmitting the related information of the matched items to the client if the match is successful.

The rechecking module 424, used for rechecking the regional images if the match is unsuccessful, and complementing the related information of the items if rechecking confirms that the regional images contain the items.

The recording module 426, used for recording time information of the matched items appearing in the current video to an item information base if the match is successful.

The first time information transmitting module, used for transmitting the time information of the matched items appearing in the other places of the current video to the client after the client receives the user instruction.

The second time information transmitting module, used for transmitting the time information of the matched items appearing in the other videos to the client after the client receives the user instruction.

In conclusion, according to the system for displaying item related information in video streaming provided by the embodiment of the present disclosure, the related information of the items is pre-stored at the server and displayed in the played video streaming of the client, the related information of the items may be acquired without searching the items through the internet and the like, and items in the video streaming are conveniently known.

Moreover, the floating layer window is displayed at the client, and normal play of the video streaming is not influenced.

The joint degree of the related information of the items and the video streaming is greatly improved, and the users may well know the related information of interested items in the video streaming watching process.

The embodiments of the system described above are only schematic, units serving as separate parts to describe may be (or not) physically separated, and parts serving as units to display may be (or not) physical units, namely the parts may be positioned in the same place or may be distributed onto multiple network units. Partial or total modules may be selected to achieve the aims of the scheme in the embodiments according to actual needs. The ordinary technical personnel in the field may understand and implement under the condition that the creative labor is not contributed.

Each of devices according to the embodiments of the disclosure may be implemented by hardware, or implemented by software modules operating on one or more processors, or implemented by the combination thereof. A person skilled in the art should understand that, in practice, a microprocessor or a digital signal processor (DSP) may be used to realize some or all of the functions of some or all of the modules in the device according to the embodiments of the disclosure. The disclosure may further be implemented as device program (for example, computer program and computer program product) for executing some or all of the methods as described herein. Such program for implementing the disclosure may be stored in the computer readable medium, or have a form of one or more signals. Such a signal may be downloaded from the internet websites, or be provided in carrier, or be provided in other manners.

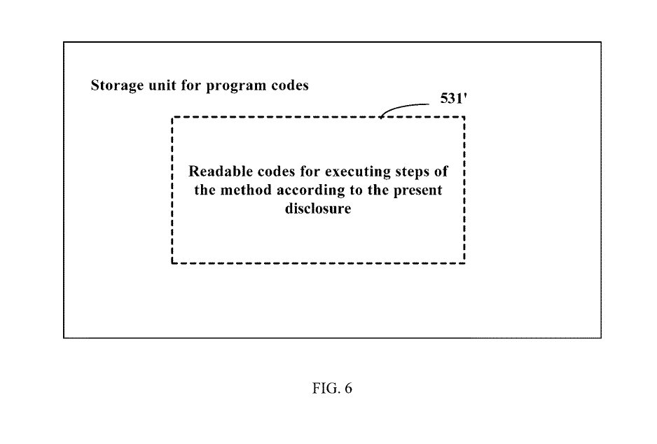

For example, FIG. 5 illustrates a block diagram of an electronic device for executing the method according the disclosure. The electronic device may be the client or the server above. Traditionally, the electronic device includes a processor 510 and a computer program product or a computer readable medium in form of a memory 520. The memory 520 could be electronic memories such as flash memory, EEPROM (Electrically Erasable Programmable Read-Only Memory), EPROM, hard disk or ROM. The memory 520 has a memory space 530 for executing program codes 531 of any steps in the above methods. For example, the memory space 530 for program codes may include respective program codes 531 for implementing the respective steps in the method as mentioned above. These program codes may be read from and/or be written into one or more computer program products. These computer program products include program code carriers such as hard disk, compact disk (CD), memory card or floppy disk. These computer program products are usually the portable or stable memory cells as shown in reference FIG. 6. The memory cells may be provided with memory sections, memory spaces, etc., similar to the memory 520 of the electronic device as shown in FIG. 5. The program codes may be compressed for example in an appropriate form. Usually, the memory cell includes computer readable codes 531′ which may be read for example by processors 510. When these codes are operated on the electronic device, the electronic device may execute respective steps in the method as described above.

The “an embodiment”, “embodiments” or “one or more embodiments” mentioned in the disclosure means that the specific features, structures or performances described in combination with the embodiment(s) would be included in at least one embodiment of the disclosure. Moreover, it should be noted that, the wording “in an embodiment” herein may not necessarily refer to the same embodiment.

Many details are discussed in the specification provided herein. However, it should be understood that the embodiments of the disclosure may be implemented without these specific details. In some examples, the well-known methods, structures and technologies are not shown in detail so as to avoid an unclear understanding of the description.

It should be noted that the above-described embodiments are intended to illustrate but not to limit the disclosure, and alternative embodiments may be devised by the person skilled in the art without departing from the scope of claims as appended. In the claims, any reference symbols between brackets form no limit of the claims. The wording “include” does not exclude the presence of elements or steps not listed in a claim. The wording “a” or an in front of an element does not exclude the presence of a plurality of such elements. The disclosure may be realized by means of hardware comprising a number of different components and by means of a suitably programmed computer. In the unit claim listing a plurality of devices, some of these devices may be embodied in the same hardware. The wordings “first”, “second”, and “third”, etc. do not denote any order. These wordings may be interpreted as a name.

Also, it should be noticed that the language used in the present specification is chosen for the purpose of readability and teaching, rather than explaining or defining the subject matter of the disclosure. Therefore, it is obvious for an ordinary skilled person in the art that modifications and variations could be made without departing from the scope and spirit of the claims as appended. For the scope of the disclosure, the publication of the inventive disclosure is illustrative rather than restrictive, and the scope of the disclosure is defined by the appended claims.

The final description is that the previous embodiments are not used for limiting the technical scheme of the present disclosure, but only for describing. Although detailed description of the present disclosure is given with reference to the previous embodiments, the ordinary technical personnel in the field should understand that the technical scheme recorded by each of the previous embodiments may be modified, or one part of technical characteristics may be equivalently replaced; however, the modification or replacement does not enable the essence of the corresponding technical scheme to get out of the spirit and scope of the technical scheme in each embodiment of the present disclosure.

What is claimed is:

1. A method for displaying item related information in video streaming, comprising:
recognizing and analyzing frame images in played video streaming by a client, and transmitting regional images according with item characteristics to a server;
adding a focus frame on the regional image by the client when the regional images and pre-stored item sample pictures are matched by the server and the match is successful; and
displaying a floating layer window after the client receives a click operation of the focus frame, and displaying related information of the matched items acquired from the server in the floating layer window.

2. The method according to the claim 1, wherein the recognizing and analyzing the frame images in the played video streaming by the client comprises:
intercepting the frame images in the played video streaming by the client according to the set time interval;
and performing image recognition and analysis on the intercepted frame images by the client.

3. The method according to the claim 1, further comprising:
acquiring time information of the matched items appearing in other places of the current video from the server after the client receives a user instruction; and
displaying at least one other video frame of the matched items appearing in the current video by the client.

4. The method according to the claim 1, further comprising:
acquiring time information of the matched items appearing in other videos from the server after the client receives the user instruction; and
displaying at least one video frame of the matched items appearing in the other videos by the client.

5. A method for displaying item related information in video streaming, comprising:
receiving regional images according with item characteristics acquired by recognizing and analyzing frame images in the played video streaming through the client by the server;
matching the regional images and the pre-stored item sample pictures by the server; and
transmitting the related information of the matched items to the client by the server if the match is successful so as to allow the client to add a focus frame on the regional images, displaying a floating layer window after the client receives the click operation of the focus frame, and displaying the related information of the matched items in the floating layer window.

6. The method according to the claim 5, further comprising:
rechecking the regional images by the server if the match is unsuccessful, and complementing the related information of the items by the server if rechecking confirms that the regional images contain the items.

7. The method according to the claim 5, further comprising:
recording time information of the matched items appearing in the current video to an item information base by the server if the match is successful.

8. The method according to the claim 5, further comprising:
transmitting the time information of the matched items appearing in the other places of the current video to the client by the server after the client receives the user instruction so as to allow the client to display at least one other video frame of the matched items appearing in the current video.

9. The method according to the claim 5, further comprising:
transmitting the time information of the matched items appearing in the other videos to the client by the server after the client receives the user instruction so as to allow the client to display at least one video frame of the matched items appearing in the other videos.

10. An electronic device for displaying item related information in video streaming, comprising:
at least one processor; and
a memory communicably connected with the at least one processor for storing instructions executable by the at least one processor, wherein execution of the instructions by the at least one processor causes the at least one processor to:
recognize and analyze the frame images in the played video streaming, and transmit the regional images according with item characteristics to a server;
add a focus frame on the regional images when the regional images and pre-stored item sample pictures are matched by the server and the match is successful;
display a floating layer window after a click operation of the focus frame is received, and display related information of the matched items acquired from the server in the floating layer window.

11. The electronic device according to the claim 10, wherein recognize and analyze the frame images in the played video streaming, and transmit the regional images according with item characteristics to a server comprises:
intercept the frame images in the played video streaming according to the preset time interval, perform image recognition and analysis on the intercepted frame images, and transmit the regional images according with item characteristics to the server.

12. The electronic device according to the claim 10, wherein execution of the instructions by the at least one processor causes the at least one processor to further:
acquire time information of the matched items appearing in other places of the current video from the server after the electronic device receives the user instruction, and display at least one other video frame of the matched items appearing in the current video.

13. The electronic device according to the claim 10, wherein execution of the instructions by the at least one processor causes the at least one processor to further:
acquire time information of the matched items appearing in other videos from the server after the electronic device receives the user instruction, and display at least one video frame of the matched items appearing in the other videos by the electronic device.

14. An electronic device for displaying item related information in video streaming, comprising:
at least one processor; and
a memory communicably connected with the at least one processor for storing instructions executable by the at least one processor, wherein execution of the instructions by the at least one processor causes the at least one processor to:
receive regional images according with item characteristics acquired by recognizing and analyzing frame images in the played video streaming by the client;
match the regional images and pre-stored item sample pictures in the item information base, and transmit the related information of the matched items to the client if the match is successful.

15. The electronic device according to the claim 14, wherein execution of the instructions by the at least one processor causes the at least one processor to:
recheck the regional images if the match is unsuccessful, and complement related information of the items if rechecking confirms that the regional images contain the items.

16. The electronic device according to the claim 14, wherein execution of the instructions by the at least one processor causes the at least one processor to:
record time information of the matched items appearing in the current video to the item information base if the match is successful.

17. The electronic device according to the claim 14, wherein execution of the instructions by the at least one processor causes the at least one processor to:
transmit the time information of the matched items appearing in the other places of the current video to the client after the client receives the user instruction.

18. The electronic device according to the claim 14, wherein execution of the instructions by the at least one processor causes the at least one processor to:
transmit the time information of the matched items appearing in the other videos to the client after the client receives the user instruction.
